(19) United States
(12) Patent Application Publication
(10) Pub. No.: US 2014/0122305 A1
(43) Pub. Date: May 1, 2014

(54) PURCHASE CARD MANAGEMENT

(71) Applicant: Global Edge LLC, Calabasas, CA (US)

(72) Inventors: William Jay Cherry, Sartell, MN (US); Cheryl Patton, Sauk Rapids, MN (US); Erich Heneke, Stewartville, MN (US); Linda Unterborn, Oronoco, MN (US)

(73) Assignee: Global Edge LLC, Calabasas, CA (US)

(21) Appl. No.: 14/063,304

(22) Filed: Oct. 25, 2013

Related U.S. Application Data
(60) Provisional application No. 61/718,615, filed on Oct. 25, 2012.

(51) Int. Cl. G06Q 40/00

(52) U.S. Cl. CPC G06Q 40/12
USPC 705/30

(57) ABSTRACT

There is disclosed a method and apparatus for purchase card management. The method includes receiving purchase card transaction data pertaining to a plurality of purchase card transactions and a plurality of purchase card users associated with the plurality of purchase card transactions from at least one purchase card operator and comparing the purchase card transaction data with a plurality of risk factor rules, at least one of the plurality of risk factor rules being a prior flagged transaction rule that identifies at least one prior transaction for a purchase card user as in violation of one of the plurality of risk factor rules. The method further includes identifying a risky transaction for the purchase card user based at least in part upon the prior flagged transaction rule, preparing a risk report identifying the risky transaction, and enabling access to the risk report by a supervisor of the purchase card user.

### RELATED APPLICATION INFORMATION

This patent claims priority from the following provisional patent application:

U.S. Provisional Patent Application No. 61/718,615 entitled “Purchase Card Management” filed on Oct. 25, 2012.

This patent is also related to Patent Cooperation Treaty application Ser. No. ______ entitled “Purchase Card Management” filed on Oct. 25, 2013.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to purchase card management.

2. Description of the Related Art

Large-scale corporate and non-profit entities often need to delegate the purchase of travel expenses, product, office supplies, marketing services and materials and various other products and services to one or more employees. An easy way to facilitate the process is to provide credit cards, cash cards, debit cards or other forms of “purchase cards” to the employees. The employee may then submit an expense form for the outlay to the employer. As the number of employees grows, management and careful oversight of those purchases is quite difficult.

To deal with this problem, sometimes pre-authorization is required. Pre-authorization for purchases of a certain type, of a certain size, for specific vendors, or based on other criteria, may be required. Purchases from some vendors may not be allowed at all. Numerous rules may be implemented, but as the number of cards available to employees grows, the management of those cards becomes cumbersome and difficult.

### DESCRIPTION OF THE DRAWINGS

FIG. 1 is a diagram of an purchase card management system.

FIG. 2 is a diagram of a computing device.

FIG. 3 is a diagram of a purchase card management system.

FIG. 4 is a flowchart of purchase card management.

FIG. 5 is an example of a purchase card management report.

FIG. 6 is an example of an employee purchase card management report.

FIG. 7 is an example of an exception report.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Description of Apparatus

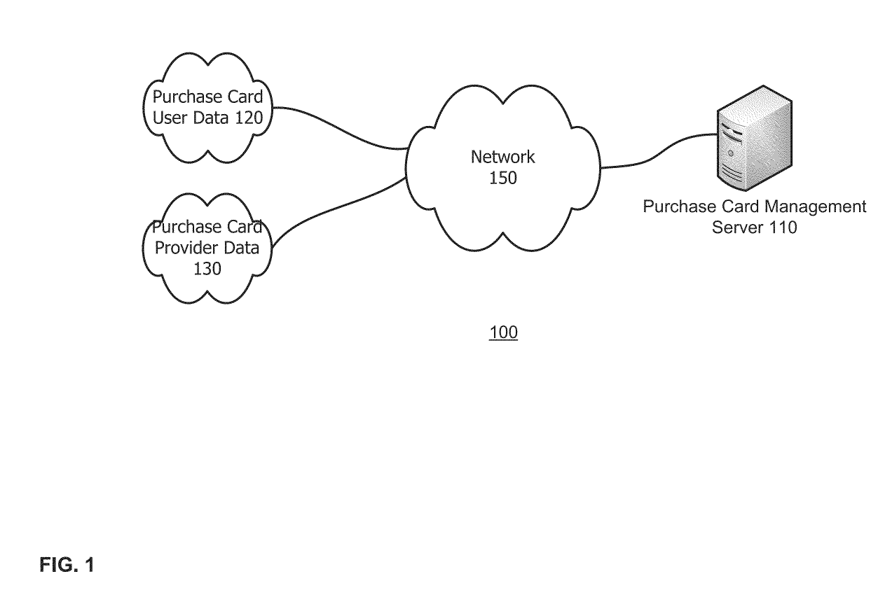

Referring now to FIG. 1, an accounts payable auditing and risk assessment system 100 is shown. The system 100 includes a purchase card management server 110, purchase card user data 120, and purchase card provider data 130 interconnected via a network 150.

The server 110 is connected to the network 150. The server 110 is shown as a computer, but may take many forms. The server 110 may be a personal computer, lap-top computer, mobile device, a tablet PC, a personal digital assistant, a smartphone, a “dumb” phone, a feature phone, a server computer operating as a part of a distributed or peer-to-peer network or many other forms.

For purposes of this patent, the term “purchase card” as used herein means a card, user ID, login or other identification used to complete purchases. Examples of purchase cards include credit cards, debit cards, cash cards, checks, account logins and associated passwords for online or other, similar purchasing systems, and similar apparatus and systems for purchases. The term “purchase card user” as used herein means an individual or entity who uses a purchase card to make purchases. The term “purchase card provider” means the individual or entity ultimately responsible for making payments for purchases made using purchase cards. For example, a purchase card user may be an employee while a purchase card provider may be an employer. The term “purchase card operator” as used herein means an individual or entity who makes payments when requested by a purchase card user. An example of a purchase card operator is a credit card company, such as VISA® or MasterCard®.

The purchase card management server 110 is a server responsible for receiving purchase card transactions, comparing those transactions with a plurality of risk rules, and identifying transactions that may involve some level of risk. A supervisor or other responsible party may then review those transactions and resolve any actual or potential risks.

The purchase card user data 120 is data provided to the server 110 by an employer, supervisor or other entity financially responsible for payment of purchases made with a purchase card. For example, the purchase card user data 120 may include data input directly by an employer regarding a purchase card user such as a name, address, title, employment status, spending limits on a purchase card and similar data. This data 120 may be input as an employee joins the payroll of a corporation or other entity and may be updated as the employee is promoted or moves among divisions of the entity.

This data 120 is shown as a single cloud, but may be an individual server housing human resources data or may be sourced from a number of data sources. Still further alternatively, this data may be input into the purchase card management system 110 directly and stored therein for referral while performing the methods described.

The purchase card provider data 130 is data provided to the server 110 by a third party, such as a purchase card operator. Access to this data may be gated by passwords or other systems. This data may be in the form of, for example, a credit card statement, online access to credit or debit card transactions, or an application programming interface (API) that enables direct, data-level access to a number of transactions for one or more purchase card users associated with a purchase card provider. Examples of this type of data include purchases made, transaction identification numbers associated with those purchases, dates, times, amounts and the entities from which those purchases were made.

This data 130 may also include so-called MCC (Merchant Category Codes) data. MCC codes are data identification numbers uniquely assigned by credit card companies that indicate specific companies or classes of goods or services either purchased or offered by the entity with whom a credit transaction was made. For example, MCC code 3000 identifies the airline United Airlines®, whereas the MCC code 0742 identifies “veterinary services.” These MCC codes can be extremely useful in identifying relevant purchase card purchases and purchases that are clearly beyond the bounds of typical purchases for a given purchase card provider or purchase card user.

The network 150 may take the form of a local network, a wide area network, the Internet or any number of other networks. The network 150 may be implemented locally by physically connected computers or may be distributed over a wide area.

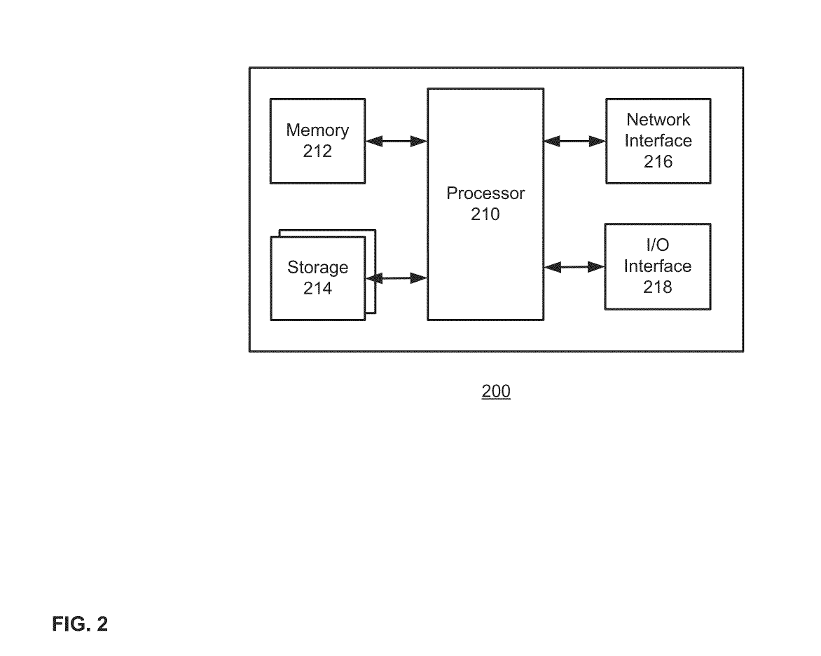

Turning now to FIG. 2, there is shown a computing device 200, which is representative of the server computers, client devices, mobile devices and other computing devices discussed herein. The computing device 200 may include software and/or hardware for providing functionality and features described herein. The computing device 200 may therefore include one or more of logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 210 coupled to a memory 212, storage 214, a network interface 216 and an I/O interface 218. The processor may be or include one or more microprocessors, application specific integrated circuits (ASICs), programmable logic devices (PLDs) and programmable logic arrays (PLAs).

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210.

The storage 214 provides non-volatile, bulk or long term storage of data or instructions in the computing device 200. The storage 214 may take the form of a disk, tape, CD, DVD, or other reasonably high capacity addressable or serial storage medium. Multiple storage devices may be provided or available to the computing device 200. Some of these storage devices may be external to the computing device 200, such as network storage or cloud-based storage. In this patent, the term “storage medium” does not encompass transient media such as signals and waveforms that convey, but do not store information.

The network interface 216 includes an interface to a network such as network 150 (FIG. 1).

The I/O interface 218 interfaces the processor 210 to peripherals (not shown) such as displays, keyboards and USB devices.

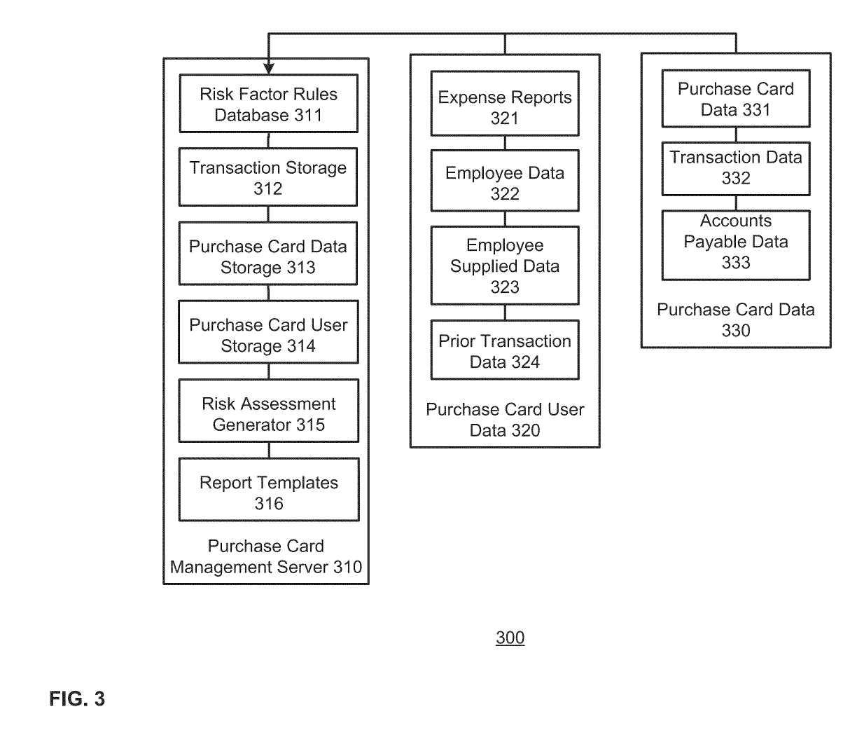

Turning now to FIG. 3, a diagram of purchase card management system 300 is shown. The system 300 includes a purchase card management server 310, purchase card user data 320, and purchase card data 330.

The server 310, which may be server 110 above, includes a risk factor rules database 311, transaction storage 312, purchase card data 313, a purchase card user 314, a risk assessment generator 315, and report templates 316.

The risk factor rules database 311 stores a plurality of rules related to purchase cards that enable the purchase card management server 310 to make determinations about which transactions by a given purchase card users should be identified as risky and to which additional scrutiny should be provided. Examples of some risk factor rules appear in TABLE 1 below.

TABLE 1

| | |
|---|---|
| High Risk MCCs | Flags transactions flagged as “High Risk” according to the client- |
| | defined MCC template |
| High Credit Limit | Checks cardholder credit limit against a low, medium and high |
| | value threshold per cycle month |
| Split Transactions | Select the risk score to be assigned for this category |
| Duplicate Transactions | Select the risk score to be assigned for this category |
| | If duplicates are expected within specific MCC codes (such as |
| | airline baggage fees), those MCC codes can be added as |
| | exceptions. Up to 100 exceptions can be entered. |
| | If a cardholder should only be audited for duplicate transactions |
| | above a certain dollar amount, specify that minimum amount. |
| Single Transaction Limit | List the amounts to be considered Low/Medium/High in terms |
| | of risk scores. |
| Percent of Credit Limit | List the spending level within a cardholder's credit limit that |
| | should be considered Low/Medium/High risk. |
| Even Transactions | Transactions can be assigned to a queue if the amount is “even,” |
| | meaning it does not include “cents” and is a multiple of $1 or $5 |
| | or $10. |
| | Determine what risk level should be assigned to an “even |
| | transaction.” |
| | Determine the minimum transaction amount to be considered for |
| | audit. |
| Merchant Keywords | Determine the risk level to be assigned to transactions with |
| | selected keywords. |
| | Certain words within a merchant name can be chosen to mark a |
| | transaction to be audited. For example, “Apple” would recognize |
| | The Apple Store as well as Applebee's. Up to 100 keywords can |
| | be entered. |
| Cash Advances | If this rule is selected, the number of cash advances can be |
| | defined to determine a low/medium/high level of risk. Likewise, |
| | the amount of each transaction can be defined which assigns a |
| | low/medium/high risk score. |
| Employment Status | Checks cardholder status against employee data uploaded to |
| | Encompass |
| Spending Limit | Checks cardholder transaction sum against a low, medium and |
| | high value threshold per cycle month |
| Policy Exceptions | Checks the number of cardholder transactions that were set to |
| | “Passed with Exception” during previous audit against low, |
| | medium, high threshold |
| Audit Rule Exceptions | Checks the number of cardholder transactions that were set to |
| | “Failed” during previous audit against low, medium, high |
| | threshold |
| Aged 30/60/90 | Identifies transactions which have elapsed a 30/60/90 day period |
| | or statement cycle without being paid. |
| Fuel Purchases | User can set low/medium/high limits for gas purchases (MCC |
| | codes: 5172, 5983, 5541, 5542, 7511) per transaction, month, |
| | year, or statement cycle. |
| Transaction Keywords | Looks for user-defined keywords in Level 3 data. |
| | Up to 100 keywords can be entered |
| Recurring Transactions | Identifies recurring transactions (same merchant, same amount) |
| | over multiple statement cycles (user can designate number of |
| | statement cycles) |
| Local Transactions | Flags transactions that occur within a user-defined number of |
| | miles surrounding a specified zip code |
| Time of Day | Flags transactions that occur during up to two user-defined time |
| | ranges |
| Weekends | Flags transactions that occur on Saturday or Sunday |
| Holidays | Flags transactions that occur on a holiday (system uses same |
| | holiday data as Global EDGE platform) |
| Airfare | Flags MCC codes of 3000-3299, 4511 or 4582 |
| Rental Cars | Flags MCC codes of 3351-3499 |
| Multi-State Transactions | Flags cardholders with multiple state transactions in a single day |
| Hotel | Flags MCC codes of 3501-3799 |
| Meals | Flags MCC codes of 5811-5814 |
| Personal Expenses | Flags MCC codes of 7217-7299 |
| Laundry Service | Flags MCC codes of 7210-7211 and 7216 |
| Parking | Flags MCC codes of 7523-7524 |
| Entertainment | Flags MCC codes of 7829-7999 |

These are merely examples of some risk factor rules. Other additional risk factor rules or fewer risk factor rules may be provided and the substance of the rules, such as percentages, numerical values, and other elements may be edited.

The risk factor rules may be variable or user-definable. For example, the first rule identified in TABLE 1 indicates that certain MCC codes may be flagged as “high risk” based upon administrator identification of those MCC codes. The server 310 may incorporate some default MCC codes that are identified as “high risk.” However, an administrator of the purchase card provider may alter this list based, among other things, upon the particulars of the employer, the employee or group to whom the purchase card is assigned.

For example, making purchases from a casino may be flagged by default for any group as “high risk.” However, if the employer is involved in an industry or entity such as the Nevada Gaming Commission that is responsible for regulating Nevada casinos, then purchase card transactions involving a casino may not be, at least as a default, “high risk.” In fact, they may occur on a regular basis. An administrator of the purchase card management system can alter the “high risk” MCC identification accordingly.

Two of the risk factor rules identified in TABLE 1 are the “policy exceptions” and “audit rule exceptions.” Both of these rules refer to situations in which an exception to a risk factor rule has been made previously. Situations in which a risk factor was previously flagged is a prior flagged transaction rule. The policy exception is a situation in which a transaction was flagged previously and in which a supervisor or an administrator allowed an exception to policy.

The audit rule exception is a situation in which a threshold level of transactions in a predetermined period for a particular purchase card user were identified as violating a risk factor rule. So, for example, if there were 5 flagged transactions previously in the last 3 months, that may trigger a “low” risk audit rule exception. If there were a total of 35 flagged transaction in the last 3 months, that may trigger a “high” risk audit rule exception. In either case, prior transactions of and the related response to those transactions for a purchase card user and/or a supervisor or administrator, may themselves be relevant in identifying “risky” transactions.

Administrators or supervisors may alter the purchase card user's credit limit or may not apply that rule (or any other rule), as desired. Keyword-related rules may identify transactions using keywords appearing in the merchant name or transaction description, or, in some cases, in any part of the documentation for a given transaction. These keywords may be defined by the administrator of the purchase card management system or, as desired, by a supervisor of one or more of the purchase card users.

Each risk factor rule may be applied to a group or to an individual. In this way, an administrator or supervisor may elect to apply a particular risk factor rule, for example, the spending limit rule identified above, to an entire group of employees. Those employees may each (or in total) be limited to a particular spending limit. In special cases, the spending limits for one employee may be separately set by an administrator or supervisor. The individual settings may override any “group” settings associated with any user. The group settings may be defined based upon the individual or group to whom a set of purchase card users reports, an employee classification such as a title, pay grade, or similar classification.

Similarly, and as will be discussed more fully below, each risk factor rule may be associated with a risk level in the risk factor rules database 311. The risk level may be, for example, “low,” “medium,” and “high” which may be represented by numbers. In the present system, the numbers 15, 30 and 60 have been chosen to represent risks that are of “low,” “medium,” and “high” risk, but other numerical and non-numerical representations are also envisioned.

The transaction storage 312 stores data pertaining to a plurality of transactions involving one or more purchase card users. This data may include an employee identification number or name associated with a particular purchase card, a plurality of transactions and associated transaction identification numbers. Detailed information regarding any transactions including amounts, taxes applied, service fees, whether multiple charges were made, the location where the charge was made, any freight or shipping cost, the merchant, the merchant type, the merchant address, the merchant tax ID (if available), any MCC code associated with the merchant or purchase, and a date on which statements are received.

The purchase card storage 313 stores purchase card data received from purchase card data 330 regarding one or more purchase cards and pertaining to one or more purchase card users. This data may include a cross-reference of the employee identification to a particular purchase card type and number along with data regarding the most recent statement balance for that purchase card user, the card expiration data, the statement date, any MCC template (such as the “high risk” MCC or specific groups of disallowed MCCS) applied to that user, the most recent activity by that user, the interest due on the account, the fees due on the account, the age of any purchase made on the account that have not yet been paid-for, any credit limit associated with the purchase card.

The purchase card user storage 314 stores data, received from the purchase card user data 320, regarding the particulars of a plurality of purchase card users. This data may include, for example, employment data such as names, addresses, email addresses, phone numbers, departments, positions, titles, current supervisor name and email, hire dates, termination date (if any) and may include notes regarding the purchase card user.

Both the purchase card data storage 313 and purchase card user storage 314 may keep data received from the purchase card data 330 and purchase card user data 320 indefinitely or may only maintain it in memory, upon receipt, for a sufficient time in order to perform a risk assessment on the data.

The risk assessment generator 315 uses the risk factor rules database 311, the transaction storage 312, the purchase card data storage 313, the purchase card user storage 314 to perform risk assessment auditing on the associated data. Based on the data, one or more of the risk factor rules in the risk factor database 311 may be violated by any one of the purchase card users shown in the transaction storage 312.

The report templates 316 enable a supervisor or other administrator to request automated reports regarding the results of the risk assessment generator 315 assessment. These reports may be, for example, in the form of a web page served to a client computer of a supervisor or an administrator or may be generated, then emailed to a supervisor or administrator for further review. Preferably, these reports enable the supervisor or administrator to perform further actions, such as emailing the purchase card user to request documentation for “flagged” transactions or to contact the supervisor of a purchase card user to request discipline or confirmation.

These report templates 316 may be edited, as desired, based upon the administrator and/or supervisor needs and may automatically ignore rules that are not being applied based upon changes made to the risk factor rules database 311.

The purchase card user data 320 is data pertaining to one or more purchase card users and includes at least four categories of data. These data include expense reports 321, employee data 322, employee supplied data 323 and prior transaction data 324.

The expense reports 321 may be expense reports submitted before or after a purchase card transaction by a purchase card user to document one or more purchases made using a purchase card. The employee data may be the data described with respect to purchase card user storage 314. It is not repeated here.

The employee supplied data 323 may be data such as additional documentation, receipts, plane tickets, images of products and similar data provided by an employee, either unprompted or at a supervisor or administrator's request in order to document or support one or more purchases using purchase cards.

The prior transaction data 324 may be data pertaining to earlier transactions involving one or more purchase card users. For example, data pertaining to previously-identified transactions that were initially identified as risky, but later allowed or later denied may be stored here. Associated documentation maybe retained as well. As will be discussed more fully below, this prior transaction data 324 may be used to refine the purchase card management system or to identify purchase card users who are repeat violators of the risk factor rules.

The purchase card data 330 is data generated by a purchase card operator regarding one or more purchase cards used by a purchase card provider and issued to one or more purchase card users. The data 330 may include purchase card data 331, transaction data 332 and accounts payable data 333.

The purchase card data 331 is data pertaining to one or more purchase cards and is described with respect to purchase card data storage 314 above. The types of data stored herein will not be repeated here.

The transaction data 332 is data pertaining to one or more transactions involving the use of a purchase card by a purchase card user. This data is described with respect to the transaction storage 312 above and will not be repeated here.

The accounts payable data 333 includes, at least, data pertaining to payments made or to be made to, for example, a purchase card operator on behalf of a purchase card user who uses a purchase card to make a purchase for a purchase card provider.

The sources of data, the purchase card user data 320 and the purchase card data 330 may be provided to the purchase card management server 310 in order that it may operate to identify transactions and purchase card users that may pose risks for a purchase card provider.

Description of Processes

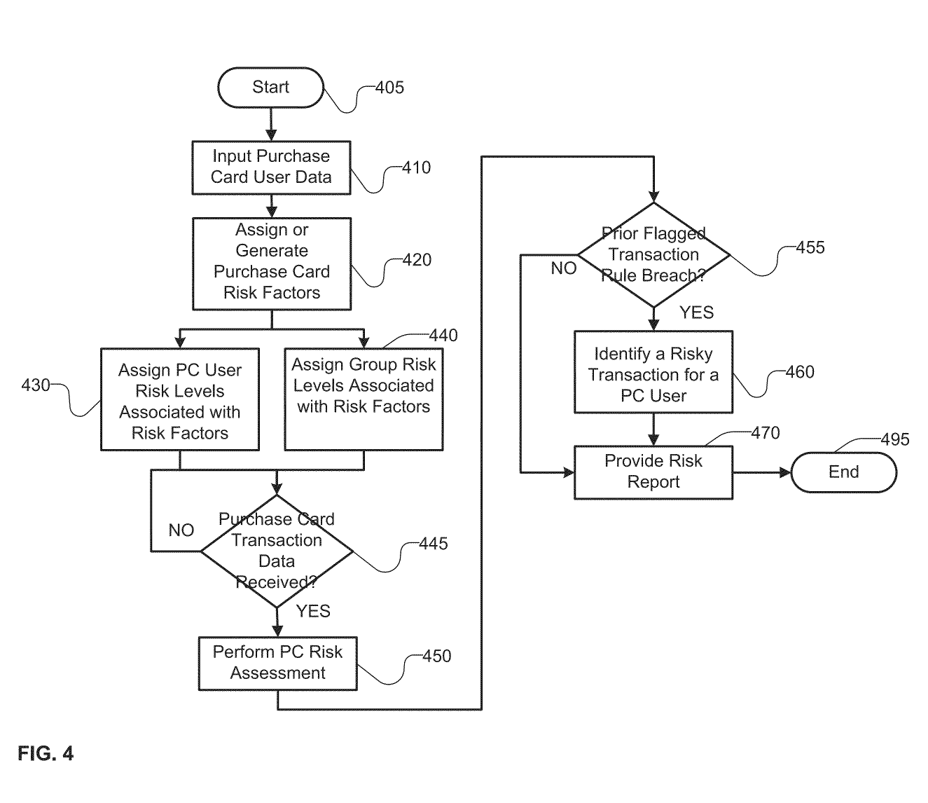

Referring now to FIG. 4, a flowchart, beginning at start 405, of purchase card management is shown. First, purchase card user data is input at 410. This process may involve both “entering” data necessary to obtain a purchase card for a purchase card user from a purchase card operator, such as a credit card company. In addition, the process may require input of the purchase card user data 320 identified above. Much of this data may be input automatically into one or more systems as a new employee is added to a purchase card provider or as an employee is promoted.

Next, a plurality of purchase card risk factor rules are assigned to the purchase card user or generated anew for the purchase card user at 420. This assignment or generation may take place automatically in response to the identification of a purchase card user as a particular title, job or having a particular supervisor within a system during the input purchase card user data 410 stage. A default set of risk factors may be used for all new hires, subject to changes by a supervisor or administrator of the purchase card management system. Alternatively, a plurality of rules may be selected and edited for a purchase card user as desired.

As a part of this process or substantially simultaneously with this process, a supervisor or administrator may assign individual risk levels to the associated risk factors selected for a purchase card user at 430 while also assigning group risk factors, for a group of which the purchase card users is a part, for one or more risk factors at 440. Group membership may be, for example, membership in a particular division, having a particular title or other similar group. The risk levels, as discussed above, may be “low,” “medium,” or “high.” The risk level may be numerical or non-numerical. Risk levels associated with various risk factor rules for some groups or individuals may be different, for example, based upon the particular purchase card user or group's job functions, locations, and level of seniority within an organization.

The system then awaits purchase card transaction data at 445. This purchase card transaction data may be the issuance of a credit card statement, automated access to a server housing purchase card transaction data, data input manually regarding purchases, or other, similar purchase card transaction data sources. Until received, the system may effectively wait at 445 using periodic checking for new purchase card transaction data.

Once data is received at 445, purchase card risk assessment is completed at 450. During this process, the risk factor rules are applied, by the risk assessment generator 315, to the purchase card transaction data, the purchase card user data, the purchase card data and any other relevant data in order to identify and apply and appropriate weighting (according to the risk factor rules) to any transactions. Transactions identified as in violation of a risk factor rule are “risky transactions.” The severity (e.g. dollar amount over a credit limit or number of prior flagged transactions) of the risk may be weighted based upon default settings or administer-altered settings of the risk assessment generator 315.

If one of the flagged transactions was previously identified by a user and is identified yet-again, this may violate a threshold indicating that the prior flagged transaction rule has been breached at 455. In particular, one of the settings associated with the prior flagged transaction rule may be a threshold of, for example, four prior flagged transactions of the same type or involving the same merchant after which, that transaction is separately flagged as in violation of the prior flagged transaction rule. So, the risk assessment generator 315 would identify the flagged transaction and, further, indicate that the prior flagged transaction rule has been violated for the purchase card user at 460. The resulting risk report provided at 470 may, for example, in the form of an email or a web page viewed by a supervisor or administrator, would highlight both issues as “risky” and have an associated risk weighting associated therewith. In such cases, the purchase card management server may be or include or have access to a web or email server.

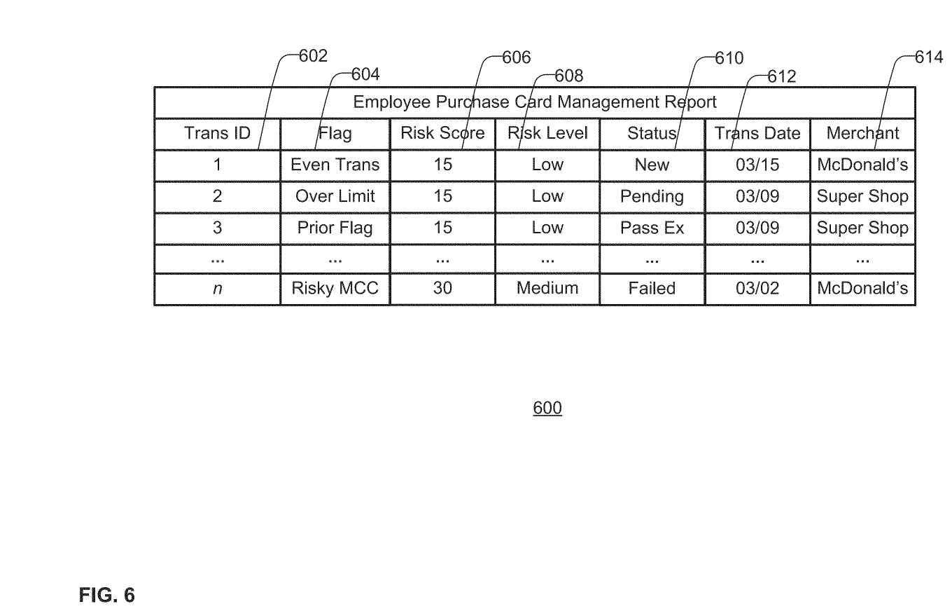

These reports may be continuously and automatically updated as additional information is received by the purchase card management server. The data used to generate the risk report 470 may be presented to a supervisor or administrator in many forms. By default, a series of “risky transactions” may be identified. However, reports of all transactions or “risky transactions” for a given purchase card user or group of purchase card users may also be presented. Selecting a purchase card user or group, for example by clicking their name or group name in a listing or by searching for the user or group using a search function, may cause only transactions, risky or all transactions, for that purchase card user or group to be displayed in a format similar to that shown in FIG. 6 (discussed below).

Further, the risk report provided at 470 may be displayed or provided to a supervisor or administrator based upon the type or “risky transaction” identified. For example, all “risky transactions” identified because they were the result of a transaction ending in an even number may be grouped. In this way, review of the transactions may be allocated to an “even transaction” supervisor or auditor. This enables concentration by one or more supervisors or auditors to work on specific types of “risky transactions.” This may be because certain types of transaction approvals or disapprovals may require higher or lower levels or review and discretion.

Still further, the risk report provided at 470 may be a part of an overall pre-defined process dependent upon the type of “risky transaction” identified and, potentially, the purchase card user or group involved in the type of “risky transaction.” These predefined processes may be provided along with the system by default, but may also be edited or editable by supervisors or administrators. In general, these processes provide a series of automated or computer-aided steps that may be taken in order to resolve a given type of “risky transaction.”

For example, after receipt of an “over limit” risky transaction identification in a report, the system may automatically send an email to a purchase card user requesting additional information about the reason that the spending has gone over the limit. Simultaneously, the purchase card user's supervisor may receive a notice of the “over limit” identification in the report and may receive subsequent email updates based upon the purchase card user's response(s). The system may then enable the purchase card user to upload documentation (for example in the form of a scanned document or an image) that is intended to support or justify the “risky transaction.” The system may then automatically incorporate that into the purchase card user storage 314 and make it available in any report generated at 470. The supervisor may then be enabled to view the documentation, using the updated risk report and to take action with the aid of the computer to accept or deny the “risky transaction.”

The priority associated with types of “risky transactions” to be processed by a supervisor or administrator (indicating which types of transactions take precedence over others in the order of processing) may be altered by a supervisor of the system. In addition, the timing of the automated and computer-assisted events may be provided in the form of a series of steps that take place in a given sequence. These may also be edited. Later reminders and changes in status of the case (and any related prompts) may also be defined and edited. As defined, prompts may be provided to all users of the system 100 at the time that relevant part of the overall process takes place.

For example, a supervisor or administrator may be prompted to check on a new “risky transaction” and asked, if appropriate, to interact with the system in order to cause it to send an email to a purchase card user or a supervisor or administrator. The user may then be prompted, for example via email, to respond. A reminder may be automatically sent a few days later if no response is received. A transaction may be automatically “failed” if no response is provided or if no action is taken by the purchase card user.

The prior flagged transaction rule is intended to identify both repeat violators of a risk factor rule and to, potentially, show situations in which a supervisor or administrator are complicit in violations of a risk factor rule. In addition, the risk factor rule that is repeatedly being identified may need to be removed or edited, either for a group as a whole or for a particular purchase card user in order to ensure that it does not continue to raise additional flags.

As additional thresholds are met for continued prior flagged transaction rule violations, the weight associated with the risk may also rise to demonstrate to an administrator or supervisor reviewing the risk report generated at 470 are aware that the issue is a problem that should be addressed.

Repeated policy exceptions or audit rule exceptions may also indicate that an administrator or supervisor is failing to identify fraud or to discipline a purchase card user for risky transactions. This may demonstrate some level of culpability on the part of the supervisor or administrator meriting further review or discussion.

The flow chart has both a start 405 and an end 495, but the process may be cyclical in nature and multiple instances of the process may be taking place simultaneously.

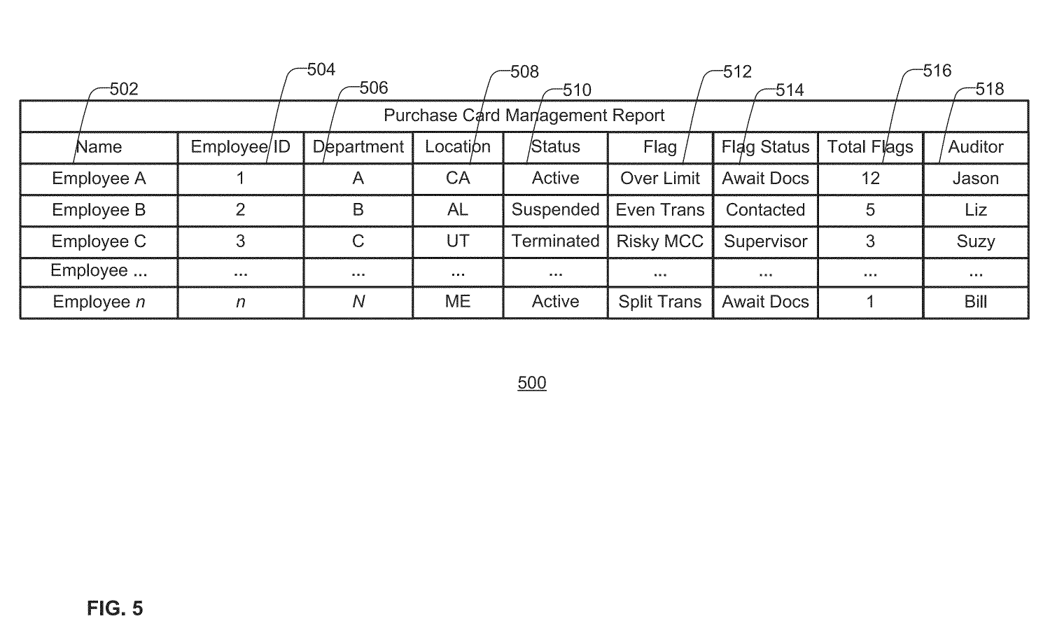

FIG. 5 is an example of a purchase card management report 500. The report identifies one or more transactions that have been identified as in violation of a risk factor rule and the most basic data associated with the transaction. The report may be dynamic such that “clicking” on a portion of the report operates as a hyperlink to provide additional information. For example, clicking on an employee name 502 may bring up a subsidiary or related report regarding the employee itself, incorporating data such as the purchase card user data 314 described above.

The employee name 502 is the name of the employee. The employee ID 504 is a unique identifier for a particular purchase card provider to identify a purchase card user. The department 506 is a division, department or other sub-division within a purchase card provider to whom the employee 502 belongs. For example, the department 506 may be research and development, human resources, engineering, sales, or other department. Location 508 is the location where the purchase card user is located. As discussed above, some risk factor rules may apply only or differently to specific group memberships, such as a department or a location.

The status 510 is the current status of the employee, such as “active,” “suspended,” “terminated,” or other, similar designations. Terminated or suspended purchase card users may have a very specific risk factor ruleset applied—such as no purchases at all being allowed or only very limited purchases. This may be yet another example of a group membership to which a risk factor ruleset may be applied.

The flag 512 may identify the specific risk factor rule that has been violated and that prompted the employee and transaction's identification in the purchase card management report 500. Clicking on the flag may bring up a summary of the meaning of the flag. For example, clicking on “over limit” may lead to a description of the rule indicating that a particular user has a spending limit of $500 and that the user has exceeded that limit. Similarly, clicking on “even transaction” may indicate that a transaction ended in an even number, such as $10 even and, as a result, was flagged.

The status of the flag 514 is an indication of what steps are being taken or have been taken with regard to the flag 512. So, for example, identification in a purchase card management report may result in an automatic email to the purchase card user identifying the risk factor rule violated and the resulting flag. This email may propose responses such as providing documentation, requesting input into a web form in explanation for the violation and inform the purchase card user (or provide a method) for the purchase card user to request an exception to the risk factor rule. Similarly, the flag status 514 may indicate that a supervisor has been contacted (and the system 300 may do so automatically or upon request) or may indicate that the purchase card user has responded or has volunteered to obtain documentation in support of an exception request.

Other status are available, such as failed or exception granted wherein the flagged transaction will no longer be listed in the purchase card management report, but may be listed in a summary report or completed report.

A running total of flags 516 may be maintained either for a predetermined period (such as a year) or for a given statement period (one month). An auditor 518 may be assigned to each case. The auditor may be a supervisor or other administrator of the purchase card management system 300.

FIG. 6 is an example of an employee purchase card management report 600. This report may be viewed when selecting (for example by “clicking” on a hyperlink in the purchase card management report 500) a particular purchase card user (such as an employee). This report 600 identifies any transactions by a particular purchase card users that violated risk factor rules.

A transaction identifier 602 may be present. This may be an identifier provided by a credit card company or associated with an expense report or other internal documentation. The flag 604 is identified for the transaction, with similar options as discussed above with regard to the risk factor rules. As can be seen, a prior flag transaction may be one of these flags 604. A risk score 606 weighting associated with the violation of that particular risk factor rule is also displayed. As discussed above, these may be set on a per-user, per-group or per-organization basis for given risk factor rules. The associated risk level 608 for a given risk score may also be shown.

The status 610 of the resolution of the flag indicates what stage of the resolution process the transaction has reached. These may be new (unseen by auditors), pending (reviewed, but not completed), passed with exception (in violation of a risk factor rule, but passed with an exception by an administrator or supervisor) or failed (not allowed after review).

The data 612 and merchant 614 associated with the flagged transaction are also identified.

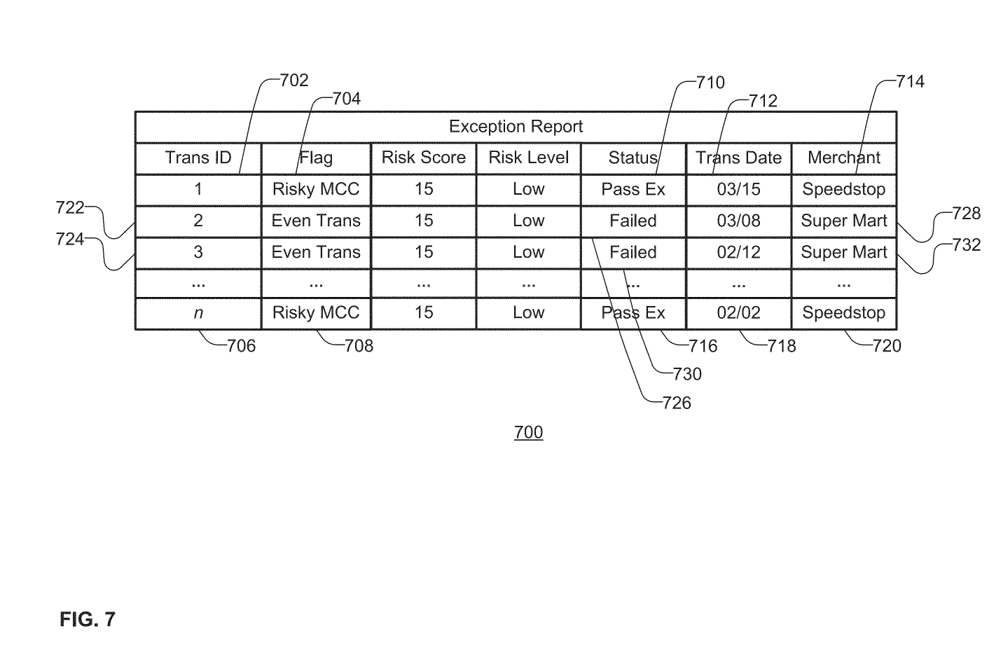

FIG. 7 is an example of an exception report 700. This report 700 is very similar to the employee purchase card management report 600, but identifies violations of the prior flagged transaction rule. Specifically, we can see that transaction 702 involved a risky MCC 704 meaning that the MCC associated with the transaction is identified as one that is likely to involve a purchase that is not allowed. The risky MCC 704 was passed with exception 710 on March 15 712 at Speedstop 714.

A similar transaction 706, with a risky MCC 708 was also passed with exception 716 on February 2 718 at Speedstop 720. Because this was passed with exception twice, this may indicate that the Risky MCC rule that caused the flag should be altered or that further investigation of these purchases should be made.

Similarly, two transactions 722 and 724 with even transactions both failed 726 and 730 and Super Mart 728 and 732. This may indicate that the purchase card user is repeatedly violating a risk factor rule and not being disciplined. Purchase card privileges may need to be curtailed or otherwise controlled. In either case, the system's identification of repeated violation of a risk factor rule itself may indicate that there is a problem meriting further investigation or alteration of the risk factor rules.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for purchase card management comprising:
receiving purchase card transaction data pertaining to a plurality of purchase card transactions and a plurality of purchase card users associated with the plurality of purchase card transactions from at least one purchase card operator;
comparing the purchase card transaction data with a plurality of risk factor rules, at least one of the plurality of risk factor rules being a prior flagged transaction rule that identifies at least one prior transaction for a purchase card user as in violation of one of the plurality of risk factor rules;
identifying a risky transaction for the purchase card user based at least in part upon the prior flagged transaction rule;
preparing a risk report identifying the risky transaction; and
enabling access to the risk report by a supervisor of the purchase card user.

2. The method of claim 1 wherein the prior transaction rule tests whether an exception being given for a purchase card transaction that was identified as in violation of one of the plurality of risk factor rules.

3. The method of claim 1 wherein the prior transaction rule tests whether reimbursement for the purchase card user for a purchase card transaction was granted.

4. The method of claim 1 further comprising:
transmitting an electronic communication to the purchase card user identifying the transaction; and
requesting supporting documentation for the risky transaction.

5. The method of claim 1 wherein the review comprises receipt of supporting documentation from the purchase card user.

6. The method of claim 1 wherein the risk report includes a plurality of risky transactions, each identified based upon one of the plurality of risk factor rules, and further including an identification of a risk factor ranking the relative risk of each of the plurality of risky transactions.

7. Apparatus comprising a storage medium storing a program having instructions which when executed by a processor will cause the processor to:
receive purchase card transaction data pertaining to a plurality of purchase card transactions and a plurality of purchase card users associated with the plurality of purchase card transactions from at least one purchase card operator;
compare the purchase card transaction data with a plurality of risk factor rules, at least one of the plurality of risk factor rules being a prior flagged transaction rule that identifies at least one prior transaction for a purchase card user as in violation of one of the plurality of risk factor rules;
identify a risky transaction for the purchase card user based at least in part upon the prior flagged transaction rule;
prepare a risk report identifying the risky transaction; and
enable access to the risk report by a supervisor of the purchase card user.

8. The apparatus of claim 7 wherein the prior transaction rule tests whether an exception being given for a purchase card transaction that was identified as in violation of one of the plurality of risk factor rules.

9. The apparatus of claim 7 wherein the prior transaction rule tests whether reimbursement for the purchase card user for a purchase card transaction was granted.

10. The apparatus of claim 7 wherein the instructions, when executed by the processor, will cause the processor to:
transmit an electronic communication to the purchase card user identifying the transaction; and
request supporting documentation for the risky transaction.

11. The apparatus of claim 7 wherein the review comprises receipt of supporting documentation from the purchase card user.

12. The apparatus of claim 7 wherein the risk report includes a plurality of risky transactions, each identified based upon one of the plurality of risk factor rules, and further including an identification of a risk factor ranking the relative risk of each of the plurality of risky transactions.

13. The apparatus of claim 7 further comprising:
the processor;
a memory;
wherein the processor and the memory comprise circuits and software for performing the instructions on the storage medium.
